(19) United States
(12) Patent Application Publication
(10) Pub. No.: US 2015/0146326 A1
(43) Pub. Date: May 28, 2015

(54) ELECTRIC ARC ELIMINATING APPARATUS

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventor: WEI-HUA CAO, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/220,351

(22) Filed: Mar. 20, 2014

(30) Foreign Application Priority Data
Nov. 22, 2013 (CN) 2013105926172

(51) Int. Cl. H02H 1/00

(52) U.S. Cl. CPC H02H 1/00
USPC 361/2

(57) ABSTRACT

An electric arc eliminating apparatus includes a power supply circuit, a voltage dividing circuit, a contacting unit, a triggering unit, a voltage control switch, an interface and a connector. When the connector is inserted into the interface but not completely connected with the interface, the contacting unit is in an open state, the power supply circuit cannot output electrical power to the connector via the interface. When the connector is inserted into and completely connected with the interface, the contacting unit is in a closed state, a voltage of the power supply circuit is divided by the voltage dividing circuit, the voltage control switch is turned on, the power supply circuit provides electrical power to the connector via the interface.

### BACKGROUND

1. Technical Field

The present disclosure relates to an electric arc eliminating apparatus.

2. Description of Related Art

Electronic devices have a number of interfaces such as USB interfaces and audio interfaces. Peripheral devices need to be inserted into interfaces of the electronic devices to transmit data. An electric arc is generated when inserting the connector into an interface. The electric arc may be stronger when an electric potential between the connector and the interface is greater than 10 volts, which is dangerous to humans.

Therefore, there is a need for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of an electric arc eliminating apparatus, the electric arc eliminating apparatus including a power supply circuit, a first switch member, a voltage dividing circuit, a voltage control switch and a interface.

FIG. 2 is a block diagram of the electric arc eliminating apparatus of FIG. 1, further including a connector, a discharging circuit and an electronic device.

FIG. 3 is a circuit diagram of the electric arc eliminating apparatus of FIGS. 1 and 2.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

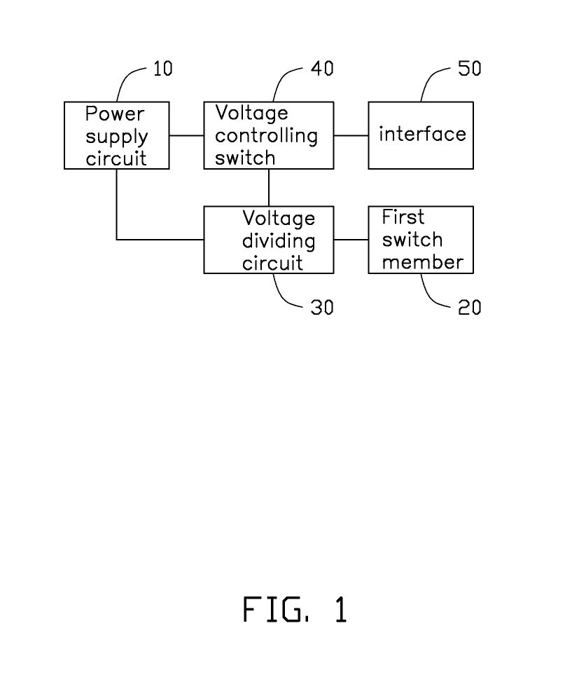

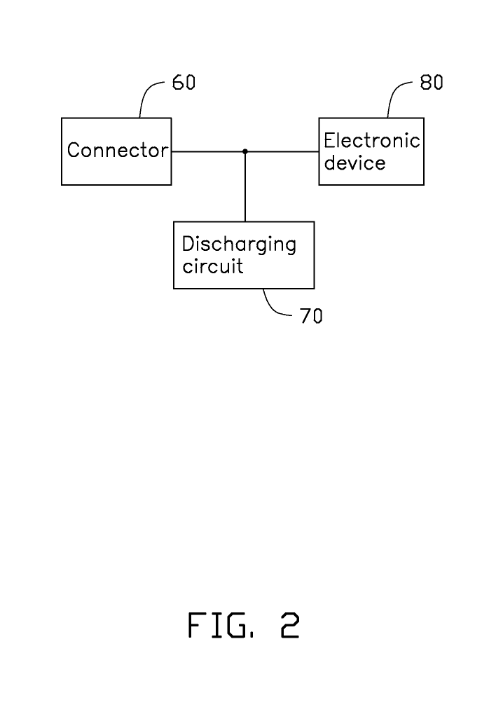

FIGS. 1 to 2 show an electric arc eliminating apparatus of the embodiment. The electric arc eliminating apparatus includes a power supply circuit 10, a first switch member 20, a voltage dividing circuit 30, a voltage control switch 40, an interface 50, a connector 60, a discharging circuit 70 and an electronic device 80.

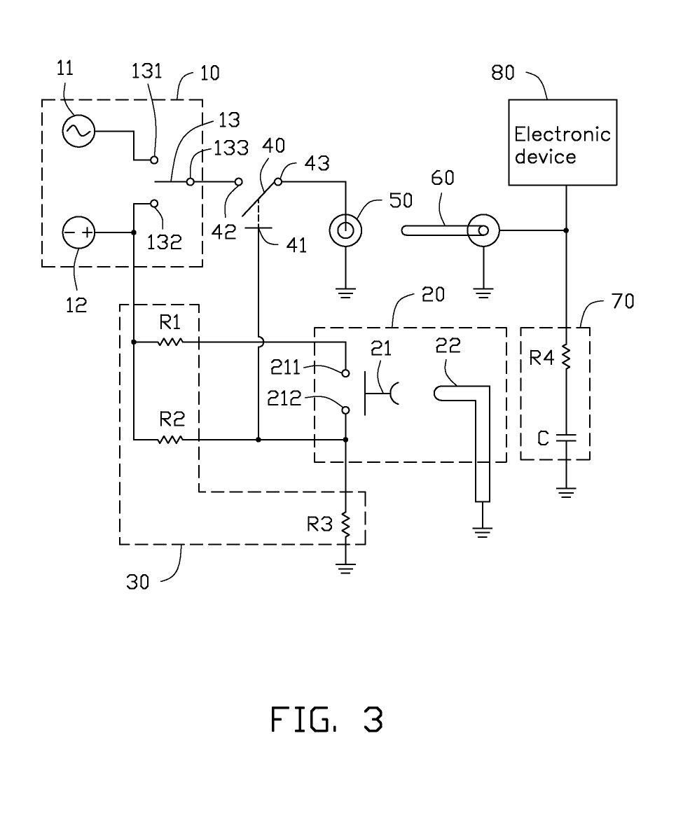

FIG. 3 shows the power supply circuit 10 includes an AC power source 11, a DC power source 12 and a single-pole double-throw (SPDT) switch 13. The SPDT switch 13 includes a first terminal 131, a second terminal 132, and a third terminal 133. The first terminal 131 of the SPDT switch 13 is electrically connected to the AC power source 11. The second terminal 132 of the SPDT switch 13 is electrically connected to the DC power source 12.

The first switch member 20 includes a contacting unit 21 and a triggering unit 22. The voltage dividing circuit 30 includes a first resistor R1, a second resistor R2 and a third resistor R3. The contacting unit 21 includes a first terminal 211 and a second terminal 212. The first terminal 211 of the contacting unit 21 is electrically connected to the second terminal 132 of the SPDT switch 13 via the first resistor R1. The second terminal 212 of the contacting unit 21 is electrically connected to the second terminal 132 of the SPDT switch 13 via the second resistor R2. The second terminal 212 of the contacting unit 21 is grounded via the third resistor R3.

In one embodiment, the contacting unit 21 is a mechanical switch point contact. The contacting unit 21 and the triggering unit 22 are located behind the interface 50. When the connector 60 is inserted into the interface 50 and completely connected with the interface 50, the connector 60 resists against the triggering unit 22 and moves the triggering unit 22 toward the contacting unit 21. The contacting unit 21 is closed to electrically connect the first resistor R1 in the circuit.

The voltage controlling switch 40 includes a control terminal 41, a first terminal 42 and a second terminal 43. The control terminal 41 of the voltage control switch 40 is electrically connected to the second terminal 212 of the contacting unit 21. The first terminal 42 of the voltage control switch 40 is electrically connected to the third terminal 133 of the SPDT switch 13. The second terminal 43 of the voltage control switch 40 is grounded via the interface 50. In one embodiment, the voltage control switch 40 is an N channel MOSFET. The control terminal 41, the first terminal 42 and the second terminal 43 are gate, drain and source respectively.

The discharging circuit 70 includes a fourth resistor R4 and a capacitor C. A first terminal of the fourth resistor R4 is grounded via the connector 60. The first terminal of the fourth resistor R4 is electrically connected to the electronic device 80. A second terminal of the fourth resistor R4 is grounded via the capacitor C.

In use, the SPDT switch 13 is pushed to select the corresponding power source providing electrical power to the electronic device 80. When the first terminal 131 and the third terminal 133 of the SPDT switch 13 are electrically connected, the AC power source 11 provides electrical power to the electronic device 80. When the second terminal 132 and the third terminal 133 of the SPDT switch 13 are electrically connected, the DC power source 12 provides electrical power to the electronic device 80.

When the connector 60 is inserted into the interface 50 but not completely connect with the interface 50, the contacting unit 21 is in an open state. The first resistor R1 is not electrically connected in the circuit. A voltage of the DC power source 12 is divided by the second resistor R2 and the third resistor R3. A voltage on the control terminal 41 is equal to a voltage on the third resistor R3.

As the voltage on the third resistor R3 is less than a turning on voltage of the voltage control switch 40. The voltage control switch 40 is turned off. The power supply circuit 10 cannot output electrical power to the connector 60 and the electronic device 80 via the interface 50. An electric potential will not be generated when inserting the connector 60 into the interface 50. Therefore, an electric arc will not be generated.

When the connector 60 is inserted into the interface 50 and completely connected with the interface 50, the contacting unit 21 is in a closed state. The first resistor R1 is electrically connected in the circuit. A voltage of the DC power source 12 is divided by the first resistor R1, the second resistor R2 and the third resistor R3. The voltage on the control terminal 41 is equal to a voltage on the third resistor R3.

As a parallel resistance of the first resistor R1 and the second resistor R2 decreases, the voltage on the third resistor R3 is greater than the turning on voltage of the voltage control switch 40. The voltage control switch 40 is turned on. The power supply circuit 10 provides electrical power to the connector 60 and the electronic device 80 via the interface 50. As the power supply circuit 10 only provides electrical power to the electronic device 80 when the connector 60 is completely connected with the interface 50, the electric arc generated by the electric potential is avoided.

When the connector 60 is inserted into the interface 50, the voltage control switch 40 is turned on slowly as the voltage on the control terminal 41 increases. A current output by the power supply circuit 10 to the electronic device 80 increases slowly. As the current received by the electronic device 80 will not increase instantly, a surge current will not be generated in the electronic device 80.

Furthermore, when the connector 60 is moved out of the interface 50, the connector 60 releases the triggering unit 22. The triggering unit 22 moves away from the contacting unit 21. The contacting unit 21 is opened again. The voltage control switch 40 is turned off. A rest current in the connector 60 and the electronic device 80 is grounded via the fourth resistor R4 and the capacitor C in sequence. Therefore, the electric arc is further avoided when the connector 60 is moved out of the interface 50.

Even though numerous characteristics and advantages of the present disclosure have been set forth in the foregoing description, together with details of the structure and function of the disclosure, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. An electric arc eliminating apparatus, comprising:
a power supply circuit;
a voltage dividing circuit;
a first switch member comprising a contacting unit and a triggering unit; the contacting unit is electrically connected to the power supply circuit via the voltage dividing circuit;
a voltage controlling switch electrically connected to the voltage dividing circuit;
a interface; the power supply circuit is grounded via the voltage controlling switch and the interface in sequence; and
a connector; wherein when the connector is inserted into the interface but not completely connected with the interface, the contacting unit is in an open state, the power supply circuit cannot output electrical power to the connector via the interface; and when the connector is inserted into the interface and completely connected with the interface, the connector resists against the triggering unit and moves the triggering unit toward the contacting unit, the contacting unit is in a closed state, a voltage of the power supply circuit is divided by the voltage dividing circuit, the voltage controlling switch is turned on, the power supply circuit provides electrical power to the connector via the interface.

2. The electric arc eliminating apparatus of claim 1, wherein the power supply circuit comprises an AC power source, a DC power source and a single-pole double-throw (SPDT) switch; the SPDT switch comprises a first terminal, a second terminal, and a third terminal; the first terminal of the SPDT switch is electrically connected to the AC power source; and the second terminal of the SPDT switch is electrically connected to the DC power source.

3. The electric arc eliminating apparatus of claim 2, wherein when the first terminal and the third terminal of the SPDT switch are electrically connected, the AC power source provides electrical power to the connector; and when the second terminal and the third terminal of the SPDT switch are electrically connected, the DC power source provides electrical power to the connector.

4. The electric arc eliminating apparatus of claim 2, wherein the contacting unit comprises a first terminal and a second terminal; the voltage dividing circuit comprises a first resistor, a second resistor and a third resistor; the first terminal of the contacting unit is electrically connected to the second terminal of the SPDT switch via the first resistor; the second terminal of the contacting unit is electrically connected to the second terminal of the SPDT switch via the second resistor; and the second terminal of the contacting unit is grounded via the third resistor.

5. The electric arc eliminating apparatus of claim 4, wherein the contacting unit is a mechanical switch of point contact; and the contacting unit and the triggering unit are located behind the interface.

6. The electric arc eliminating apparatus of claim 1, further comprising an electronic device and a discharging circuit; the electronic device is grounded via the connector and the discharging circuit respectively; and when moving the connector out of the interface, the connector and the electronic device are grounded and discharge via the discharging circuit.

7. The electric arc eliminating apparatus of claim 6, wherein when moving the connector out of the interface, the connector releases the triggering unit, the triggering unit moves away from the contacting unit, the contacting unit is opened, the voltage controlling switch is turned off, and the power supply circuit cannot output electrical power to the connector and the electronic device via the interface.

8. The electric arc eliminating apparatus of claim 6, wherein the discharging circuit comprises a fourth resistor and a capacitor; a first terminal of the fourth resistor is grounded via the connector; the first terminal of the fourth resistor is electrically connected to the electronic device; and a second terminal of the fourth resistor is grounded via the capacitor.

9. An electric arc eliminating apparatus, comprising:
a power supply circuit;
a voltage dividing circuit;
a first switch member comprising a contacting unit and a triggering unit; the contacting unit is electrically connected to the power supply circuit via the voltage dividing circuit;
a voltage controlling switch electrically connected to the voltage dividing circuit;
an interface; the power supply circuit is grounded via the voltage controlling switch and the interface in sequence;
a discharging circuit; and
an connector grounded via the discharging circuit; wherein when the connector is inserted into but not completely connected with the interface, the contacting unit is in an open state, the power supply circuit cannot output electrical power to the connector via the interface; when the connector is inserted into the interface and completely connected with the interface, the connector resists against the triggering unit and moves the triggering unit toward the contacting unit, the contacting unit is in a closed state, a voltage of the power supply circuit is divided by the voltage dividing circuit, the voltage controlling switch is turned on, the power supply circuit provides electrical power to the connector via the interface; and when the connector is moved out of the interface, the connector is grounded and discharges via the discharging circuit.

10. The electric arc eliminating apparatus of claim 9, wherein the power supply circuit comprises an AC power source, a DC power source and a single-pole double-throw (SPDT) switch; the SPDT switch comprises a first terminal, a second terminal, and a third terminal; the first terminal of the SPDT switch is electrically connected to the AC power source; and the second terminal of the SPDT switch is electrically connected to the DC power source.

11. The electric arc eliminating apparatus of claim 10, wherein when the first terminal and the third terminal of the SPDT switch are electrically connected, the AC power source provides electrical power to the connector; and when the second terminal and the third terminal of the SPDT switch are electrically connected, the DC power source provides electrical power to the connector.

12. The electric arc eliminating apparatus of claim 10, wherein the contacting unit comprises a first terminal and a second terminal; the voltage dividing circuit comprises a first resistor, a second resistor and a third resistor; the first terminal of the contacting unit is electrically connected to the second terminal of the SPDT switch via the first resistor; the second terminal of the contacting unit is electrically connected to the second terminal of the SPDT switch via the second resistor; and the second terminal of the contacting unit is grounded via the third resistor.

13. The electric arc eliminating apparatus of claim 12, wherein the contacting unit is a mechanical switch of point contact; and the contacting unit and the triggering unit are located behind the interface.

14. The electric arc eliminating apparatus of claim 9, further comprising an electronic device; the electronic device is grounded via the connector and the discharging circuit respectively; and when moving the connector out of the interface, the electronic device is grounded and discharges via the discharging circuit.

15. The electric arc eliminating apparatus of claim 14, wherein when moving the connector out of the interface, the connector releases the triggering unit, the triggering unit moves away from the contacting unit, the contacting unit is opened, the voltage controlling switch is turned off, and the power supply circuit cannot output electrical power to the connector and the electronic device via the interface.

16. The electric arc eliminating apparatus of claim 14, wherein the discharging circuit comprises a fourth resistor and a capacitor; a first terminal of the fourth resistor is grounded via the connector; the first terminal of the fourth resistor is electrically connected to the electronic device; and a second terminal of the fourth resistor is grounded via the capacitor.
